(19) United States
(12) Patent Application Publication
(10) Pub. No.: US 2015/0025911 A1
(43) Pub. Date: Jan. 22, 2015

(54) METHODS AND SYSTEMS FOR DISTRIBUTING SENSITIVE OR CONFIDENTIAL INFORMATION

(71) Applicant: WebMD, LLC, New York, NY (US)

(72) Inventors: Nick Altebrando, New York, NY (US); Krishna Bhagavathula, New York, NY (US); Michael Morello, New York, NY (US); David Ziegler, New York, NY (US); Michael Glick, New York, NY (US)

(73) Assignee: WEBMD, LLC, New York, NY (US)

(21) Appl. No.: 14/334,292

(22) Filed: Jul. 17, 2014

Related U.S. Application Data
(60) Provisional application No. 61/847,401, filed on Jul. 17, 2013.

(51) Int. Cl. G06F 19/00

(52) U.S. Cl. CPC G06F 19/322
USPC 705/3

(57) ABSTRACT

Systems and methods are disclosed for providing a communication network allowing a user transmit confidential or sensitive information to a recipient through a third party, while ensuring that privacy is maintained. A user can access a mobile application to request a third party to send information to a recipient. Following the user request, a built-in procedure of the mobile application may automatically institute a consent process between the third party and the desired recipient, without requiring any further action on the part of the requesting user. A coded message may be delivered to the intended recipient, including a selectable link directing them to a consent procedure within the third party communication network service. Completion of the consent procedure creates an association between the requesting user and the intended recipient within a relationship database, allowing confidential information to be exchanged between the user and recipient, through the third party communication service.

### BACKGROUND OF THE INVENTION

During treatment of a patient, a physician may wish to provide the patient with additional information regarding that patient's continued treatment, such as upcoming procedures, after-treatment care, or prescribed medicines. Although the physician may provide this additional in person through additional office visits, this can be both time consuming and inconvenient. With the increase in electronic communications, it is now possible for patients and physicians to communicate over electronic devices, such as personal computers, mobile phones, smartphones, tablets, and PDAs. In order to communicate such information through third parties, it may be necessary for the third party to become a business associate of the health care provider for the purposes of the Health Insurance Portability and Accountability Act (HIPAA) in order to share medical information about the patient with the third party in order for the third party to provide information to the patient about the patient's condition.

However, it may be undesirable for a third party to become a business associate. While obtaining the consent of the patient to share the patient's medical information with the third party would eliminate the need for the third party to become a business associate, providers such as treating physicians may not have the time to complete lengthy consent procedures between themselves, the patient, and the third party before the third party may communicate the confidential information.

Therefore what is needed is a system that allows for confidential information to be transmitted through a third party without requiring complex secure transmissions systems or the need for establishing a business associate relationship to comply with the HIPAA privacy rules.

### SUMMARY OF THE INVENTION

The present invention includes systems and methods for providing a communication network allowing a first party to have confidential or sensitive information transmitted to a second party by a third party, while ensuring that privacy is maintained. According to some embodiments, the first party may be a health care provider, the second party may be a patient, and the confidential or sensitive information may be information related to the patient by a third party who has the information that the provider wants sent to the patient. However, the first party may be any entity that wishes to have potentially confidential or sensitive information sent to a second party by a third party. For example, the first party may be a bank or financial advisor wishing to have a third party send confidential financial information to a customer. For illustrative purposes only, the following disclosure has been provided in the context of sharing health care information.

The communication network, which may be provided by a third party, may provide a mobile application acting as a user interface for health care providers, such as physicians, nurses, or pharmacists. The communication network may further include a second mobile application acting as a user interface for patients or other users to receive information from health care providers. In some embodiments, the health care provider user interface and patient user interface may be embodied in the same mobile application. Each mobile application may be implemented as a program running on a computing device, such as a smartphone, PDA, tablet, laptop computer, notebook computer, or other mobile device. The mobile applications may be stored in a memory module on the device, and executed by one or more processors within the device. The memory may include local memory such as RAM, ROM, hard drives, optical storage, flash memory, or other electronic storage mediums. In addition, the program instructions and data for operating the mobile application may be stored in a cloud-based server, accessible by the mobile device through a communication module. The user interfaces may also be provided through a website accessed over an internet connection. As described in more detail below, the mobile applications may include program instructions forming a set of program modules.

Any time health care related information is transmitted between treating physicians or other health care provider and a patient, there are concerns about keeping the patient's health information private. Therefore, when a health care provider accesses the user interface to send information to a patient, the entity hosting the communication network may automatically transmit a consent form to the patient, using a patient identifier given by the health care provider. This patient identifier may be a mobile phone number, email address, or user name. In order to ensure privacy, the communication network may only transmit a message that the health care provider wishes to share information, along with instructions for the user to provide consent to receive health related information through the communication network. However, in order to avoid the complications of becoming a business associate for the purposes of HIPAA, the consent form may indicate that the patient's information will be protected by the communication network's own privacy policy, but that based on the patient's consent it will not be covered by HIPAA. Once a user provides the necessary consent, the health care provider may use the communications network as a third party to provide information to the patient, and in some embodiments the patient may also use the network to provide information to the health care provider. Before the patient provides consent, the third party communication network will not receive any indication as to identity of the patient or the content of the information the health care provider wished to transmit. The identity of the patient is kept from the communications network through the use of a second communications platform such as an email or text messaging vendor.

If a patient declines to provide consent, the communication network or other third party will not receive the identity of the patient. However, the communications network may transmit a second message to the patient informing them that the communication network or other third party will be unable to provide the information sent from the health care provider, and further directing the patient to inform the health care provider of their decision not to consent to receiving information through the communication network.

Once patient consent has been established, the health care provider and patient may share information through the user interfaces, or through other communications sent through the communications network.

### BRIEF DESCRIPTION OF THE FIGURES

FIG. 1 is an illustration of mobile application home page for a health care provider.

FIG. 2 is an illustration of an example of an informational screen explaining the privacy policy and consent procedures of the current invention.

FIG. 3 is an illustration of a patient instruction module within the mobile application.

FIG. 4 is an illustration of a content selection screen within the patient instruction module.

FIG. 5 is an illustration of a send instructions module.

FIG. 6 is an illustration of a main screen of a patient instruction module within the mobile application.

FIG. 7 is an illustration of a topic search within the patient instruction module.

FIG. 8 is an illustration of a content selection display within the patient instruction module.

FIG. 9 is an illustration of a content preview screen within the patient instruction module.

FIG. 10 is an illustration of a message screen within the patient instruction module.

FIG. 11a is an illustration of patient notification using a text message.

FIG. 11b is an illustration of patient notification using an email message.

FIG. 12a is an illustration of a consent page within the communication network service.

FIG. 12b is an illustration of a consent page within the communication network service after a patient has input required information.

FIG. 13 is an example of a message on a user interface when a patient declines to provide consent.

FIG. 14 is an illustration of a referee page presented to a patient within the communication network service after the patient provides consent.

FIG. 15 is an illustration of a patient sign in page.

FIG. 16 is an illustration of a patient message page.

FIG. 17 is an example of a user display of selected message content related to a disease or condition.

FIG. 18 is an example of a user display of selected message content related to drug information.

FIG. 19 is an example of a message inbox page for a user within the communication network service.

FIG. 20 is an example process for establishing patient consent within the network communication service to allow messages to be transmitted from a health care provider to a patient.

FIG. 21 is an example of the process for transmitting a message and message content from a health care provider to a patient within the network communication service when both the health care provider and patient are already registered members, and wherein the patient's consent is currently active.

FIG. 22 is an example of establishing connectivity between a health care provider and a patient where a patient's previous consent has expired.

### DETAILED DESCRIPTION OF THE INVENTION

A communications network service allowing health care providers to send health care related information to patients through a third party that may provide a mobile application or other user interface is provided. The mobile application or other user interface may be connected to a server in the communications network service. The server in the communications network service may include a database of health care related information stored thereon. Alternatively, the database of health care related information may be stored in a separate memory accessible by, or in communication with, the server. A health care provider wishing to send information to a patient may be provided with access to this database of information, or the service may allow the health care provider to search for the desired content by keyword. When a health care provider has identified the content they wish to send to a patient through the communication network service, the communication network service may retrieve this information from the database and attach it to a token using a content or condition ID. Alternatively, the information may be obtained from an internet search, hospital database, library, medical journal, newspaper article, or pamphlet. Although the information may typically be in electronic form, it would also be possible for the health care provider to request that a printed publication, such as a journal article or pamphlet, be physically sent to the patient. To facilitate the process of sending information to a patient through the third party communication network, the health care provider may only be required for perform a single step of requesting that the communication network send certain information to a patient by using the mobile application. The mobile application, or other user interface, may be connected to the server by various types of networks, including LAN, WAN, Intranet, Internet, cellular, or any other wired or wireless communication medium.

Following the health care provider's request, a built-in procedure of the mobile application may automatically institute a consent process between the communication network and the desired recipient, without requiring any further action on the part of the physician. The communication network sends a coded message to the patient. By selecting a link within the coded message, the patient is directed to a consent procedure within the communication network service. Completion of the consent procedure allows the communication network to transfer potentially confidential patient health information from the health care provider to the communication network so that the communication network can provide information to the patient on behalf of the provider without needing to become a business associate of the provider for the purposes of HIPAA.

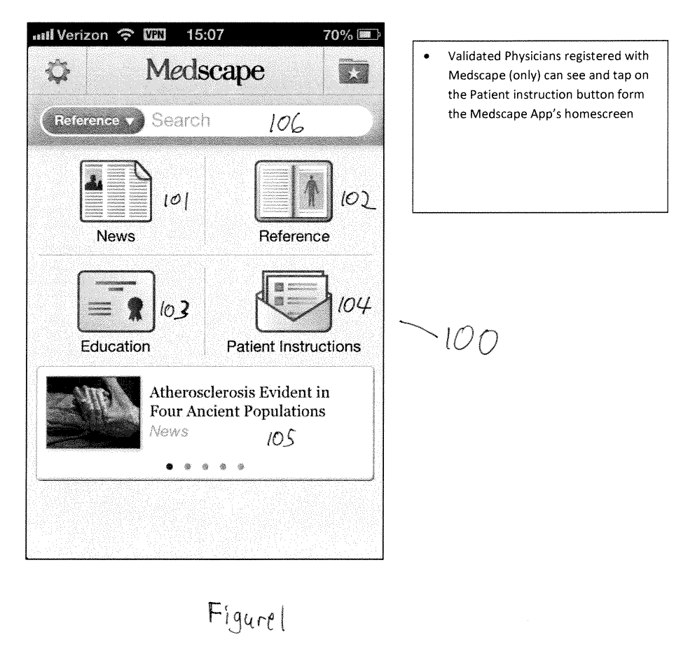

As shown in FIG. 1, a health care provider using the communications network service may be provided with a user interface 100 through a networked application executed on a mobile device, such as a smartphone, PDA, notebook computer, laptop computer, or tablet computer. The mobile applications may be stored in a memory module on the device, and executed by one or more processors within the device. The memory may include local memory such as RAM, ROM, hard drives, optical storage, flash memory, or other electronic storage mediums. In addition, the program instructions and data for operating the mobile application may be stored in a cloud-based server, accessible by the mobile device through a communication module. The mobile device may have a communication interface, allowing wired or wireless communication with other network devices, or with cloud-based storage systems. The user interface may include a home page, such as shown in FIG. 1, allowing the health care provider to organize, receive, and share health care related information. The user homepage may include a selectable news option 101, selectable reference option 102, a selectable education option 103, and a selectable patient instruction option 104. According to certain embodiments of the invention, a health care provider may be required to first register with the communications network before being able to access certain features of the service. For example, only registered, validated health care providers may be able to see or access the selectable patent option 104 for transmitting instructions or other information to a particular patient. A health care provider may register with the communication network through the mobile application itself, or the health care provider may be directed to a webpage hosted by the communication network to complete registration. Registration may including generating a user name and password, which are then input into the user interface of the mobile application to allow the health care provider access to all features of the service.

As illustrated in FIG. 1, the user interface home page may include a scrolling news feed 105 providing information specific to the areas of interest of the registered health care provider. The home page may further include a search or reference feature 106, allowing the user to search within their personal information and contacts stored within the mobile application, to search information stored in a larger database hosted by the communication network, or to search on the internet.

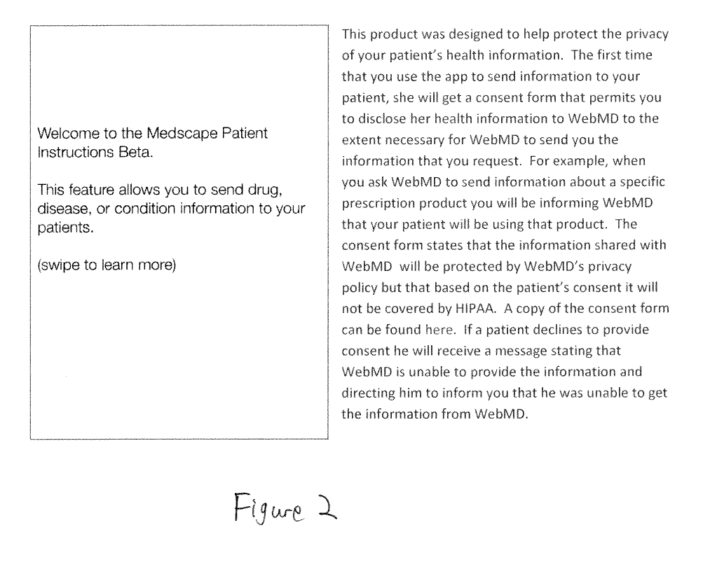

Due to concerns over keeping patient information private, the mobile application may automatically display an informational screen explaining the process for sending instructions or information to a patient the first time the health care provider selects the patient instruction option 104 from FIG. 1. As seen in FIG. 2, this informational screen may appear for all users that select the patient instruction option 104 from the home page. The informational screen may include several display screens, and the user may be required to scroll through multiple pages to review the informational screen in its entirety. The mobile application may require the health care provider to review the informational screen in its entirety, and may require the user to select a checkbox or other indicator within the display screen acknowledging that they understand the policy and procedure involved in sending information to a patient. Selection of this checkbox or other indicator may also serve to disable the informational screen from being displayed upon future selections of the patient instruction option 104.

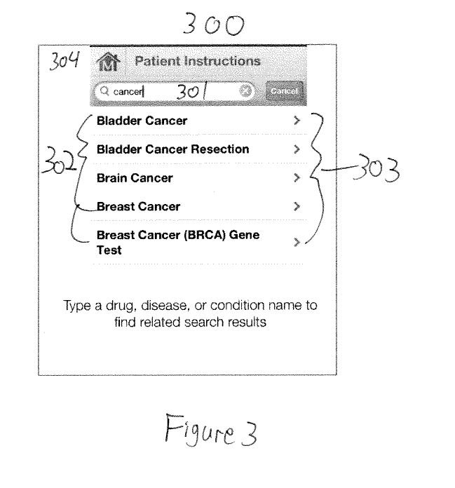

FIG. 3 is an example of a display within the mobile application following selection of the patient instruction option 104 from FIG. 1. Selection of the patient instruction option 104 causes the mobile application to open a patient instruction module 300. The patient instruction module 300 includes a search feature 301, and a results display 302. The patient instruction module further includes a selectable icon 304 allowing the user to return to their home page within the mobile application. The search feature 301 allows a physician or other health care provider to enter search terms for treatment, drugs, diseases, condition names, or other information related to the care of a specific patient or patients in general. For example, a physician treating a patient for cancer may wish to provide specific information to a patient following an in-person visit. This information may include after-care instructions, information on follow-up procedures, information regarding a diagnosis made during an in-person visit, test results, or information related to a suggested or planned surgery. In embodiments of the present invention directed to confidential information outside of the health care context, the information may include bank account information, credit information, loan information, or any other type of sensitive personal information.

As illustrated in FIG. 3, a physician of other health care provider may enter a search term, such as “cancer,” into the search feature 301. The results display 302 may then display a list of results related to the entered term, such as “Bladder Cancer,” “Bladder Cancer Resection,” “Brain Cancer,” “Breast Cancer,” and “Breast Cancer (BRCA) Gene Test” for the searched term “cancer.” Each item within the results display may include a selectable icon 303, allowing the user to receive additional information about that specific result. For example, selection of the icon 304 next to the “Brain Cancer” result may cause the mobile application to open additional windows of information on that topic, or may cause the mobile application to update the results screen to display a narrowed list of results related only to Brain Cancer. The results display may be organized in any matter, including listing results in alphabetical order or by relevance. Once a term has been searched, the mobile application may record the selected results made by a user, and may offer these prior selections as the first results in the display when the user searches the same term at a future time. The search feature may allow a user to search information stored within any electronically accessible database, such as information stored within the application itself, information in a database hosted by the communication network, or on the internet. When information is found on the internet, the results list may include a link to a specific webpage.

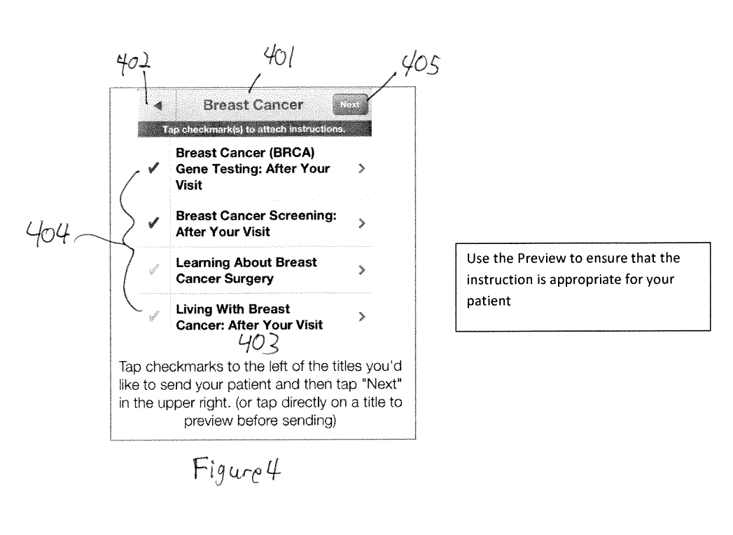

FIG. 4 is an illustration of the patient instruction module 300 within the mobile application following selection of an item from the results display 302 shown in FIG. 3. As shown in FIG. 4, the mobile application may display the keyword 401 of the selected result from the result display 302. The mobile application may further display a selectable icon 402 allowing a user to return to the previous results display shown in FIG. 3. The mobile application may include titles of information 403 related to the selected keyword, along with a selectable option 404 next to each title marking that title for transmission to a patient. A user may select the options 404 next to each title of information that they wish to send to a patient, and then may select an option 405, such as a “Next” option, to begin the process of sending the selected titles to specific patients. Alternatively, the user may tap on each title or an icon next to each title to allow the user to preview the information before beginning the process to send to a patient. Using the preview feature may allow a user to ensure that the selected instruction title is appropriate for the patient.

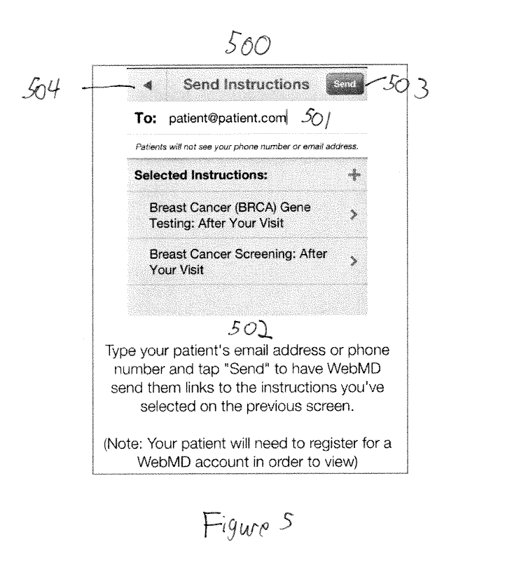

FIG. 5 is an illustration of a send instructions module 500 within the patient instruction module 300. The send instructions module 500 may be displayed within the mobile application following user selection of option 405 to begin the process to send selected information to a patient. The send instructions module may include a recipient patient address identifier area 501, a list of the instructions selected for transmission 502, and an option to send 503 the selected information to the patient address entered in area 501. A return option 504 may also be included to allow the user to return to the previous screen within the patient instruction module 300. The recipient patient's address may be an email address, mobile phone number, or other unique patient identifier user name or number. Upon selection of the option to send 503, the communication network will transmit links to the selected instructions to the identified patient. The links may be sent in an email, text message, message within a patient's mobile application, or link displayed on a webpage accessible by the patient. The links may direct the patient to webpages hosted by the communication network, or may open informational and instruction pages within a mobile application accessed by the user. The communications network will send the provider's request to a third party, who sends a message to the patient to obtain his consent to allow the communications network to obtain the patient's identity. The communication network will not obtain any information identifying the patient unless and until the patient grants consent.

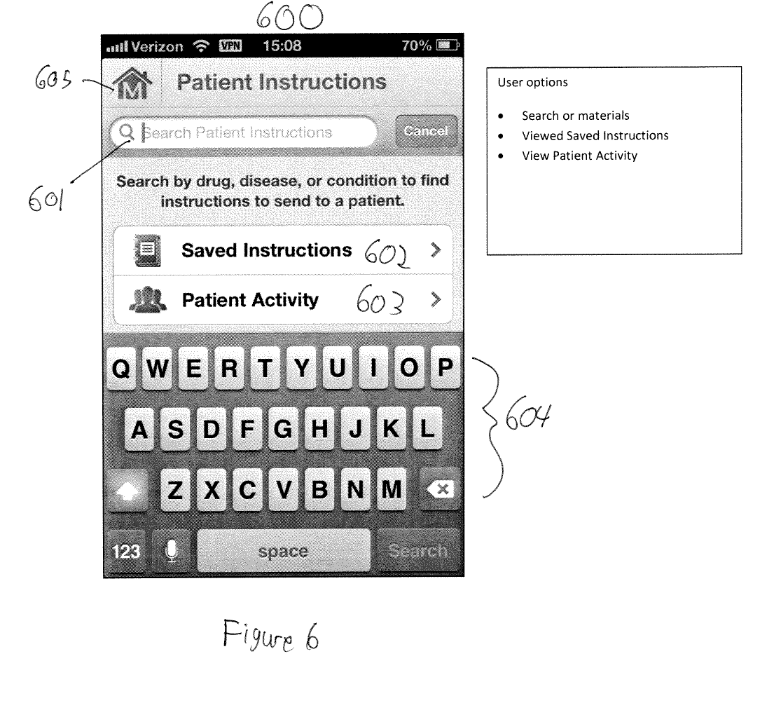

FIG. 6 is an illustration of the main screen 600 of the patient instruction module. The main screen includes a search bar 601 allowing the user to search for patient instructions. The main screen 600 further includes links allowing the user to review previously saved patient instructions 602, or to review patient activity 603. The mobile application may include a data input area 604, which may be a touchscreen or physical keyboard, or other data entry mechanism. A home button 605 may allow the user to return to the home screen of the mobile application.

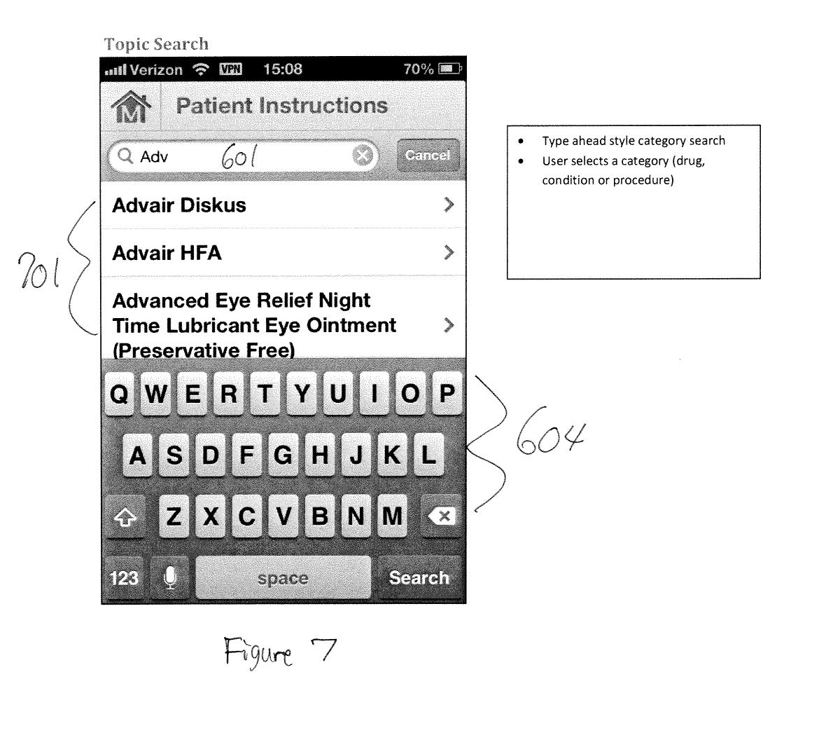

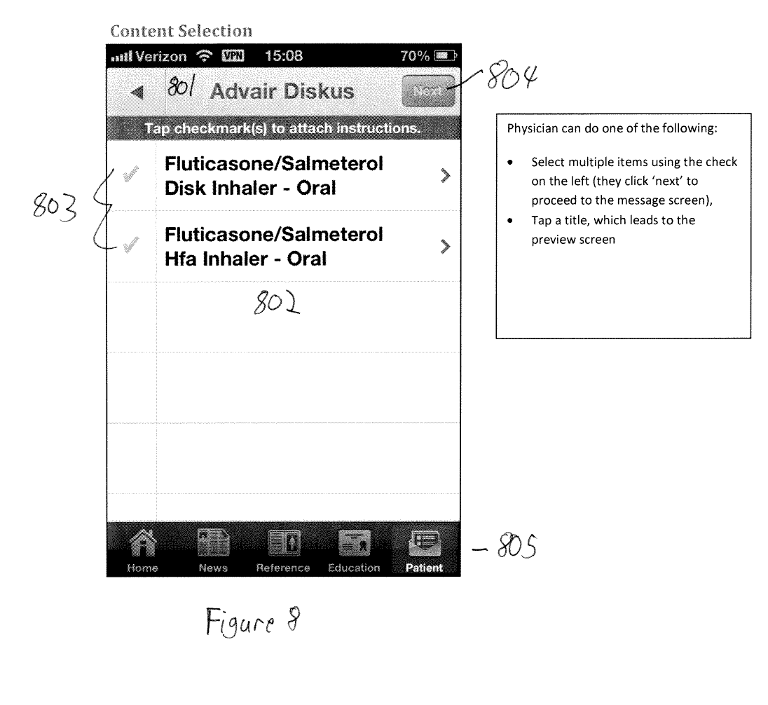

FIGS. 7-10 illustrate the process of a user entering search information into the patient instruction module, selecting instructions, and previewing and sending the instructions to a specific patient. As shown in FIG. 7, a user may use the data input area 604 to enter information into the search bar 601. Results of the search term or terms input into search bar 602 may be displayed in area 701. According to some embodiments, the mobile application may include a “type ahead” category search feature, wherein the display area 701 continuously updates the displayed results as the search term is being input. For example, as shown in FIG. 7 the results area includes results for “Advair Diskus” and “Advair FHA” even though only the letters “Adv” have been input. Once display area 701 shows the desired category or keyword, the user may select that item from the display as a content selection. FIG. 8 illustrates an example of the patient instruction module following a user making a content selection. The category selected may be displayed at 801, and instruction titles 802 related to that category may also be displayed. The mobile application may include selectable icons 803 for choosing certain instruction titles. The user may choose on or more of the displayed titled 802 by using the selectable icons 803. The user may then choose an option 804, such as a “Next” option, to proceed to a message screen within the mobile application for sending the instructions to a patient. If the user wants to preview the selected instructions before sending to a patient, the user may select each title from the displayed results to proceed to a preview screen. For example, the user may click or touch directly on the title itself, or a separate icon next to the title to move a preview screen displaying the instructions related to that title. The content selection screen shown in FIG. 8 may also include selectable icons 805 allowing a user to directly navigate to the homepage of the mobile application, or to any other module within the mobile application. These icons 805 may be displayed at all times within the mobile application, or may only be displayed within certain modules or windows of the application.

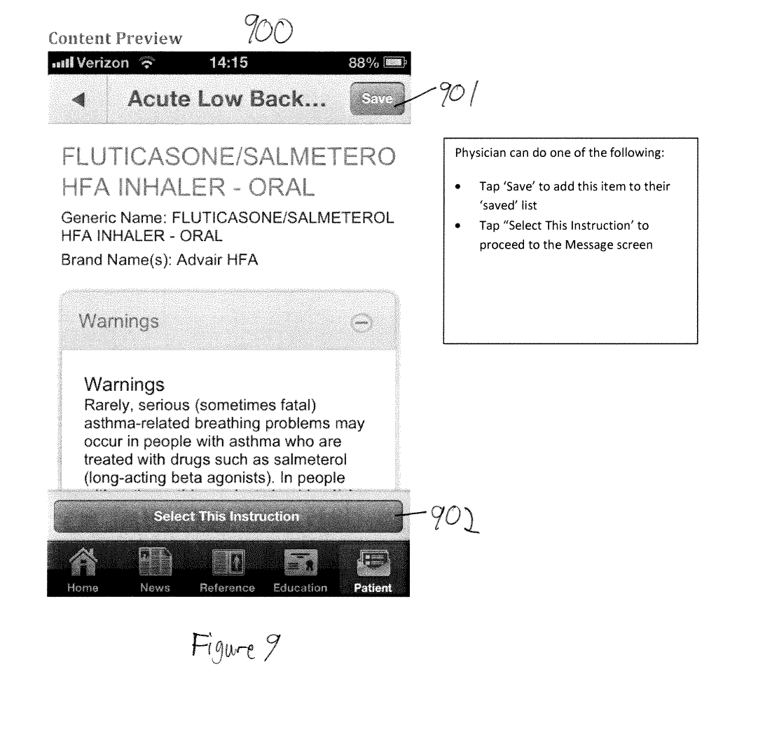

FIG. 9 illustrates an example of a content preview screen 900, which may be displayed within the mobile application when the user chooses to preview the instruction results before sending. The content preview screen may include a save option 901 and a selection option 902. The save option 901 adds the item to the user's saved instructions, which can be accessed through the patient instruction main screen as described above. The selection option 902 causes the mobile application to proceed to the message screen for sending the instruction to a patient.

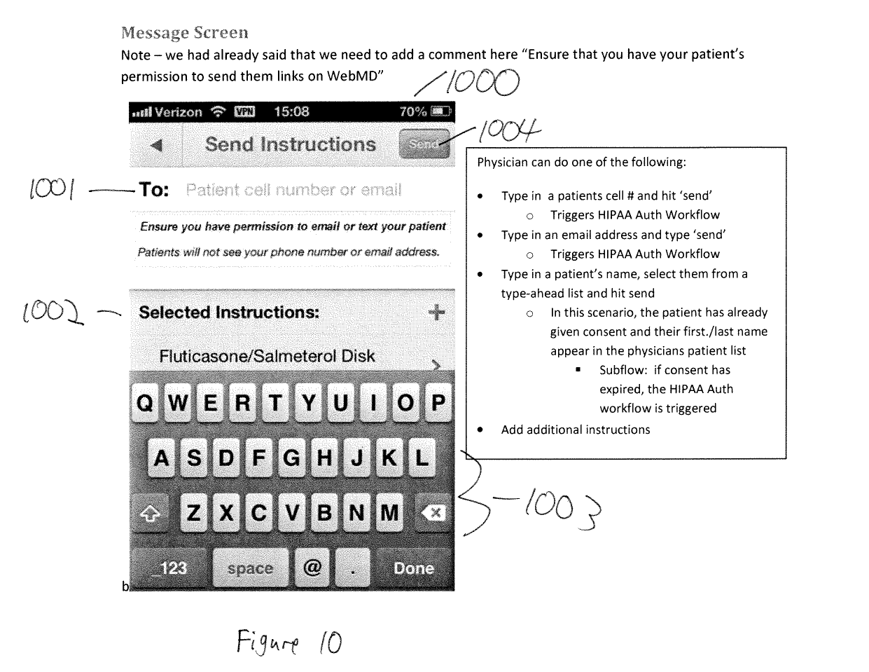

FIG. 10 shows another example of a message screen 1000, similar to that shown in FIG. 5. As discussed in FIG. 5, the send message screen may include a recipient patient address identifier area 1001, a list of the instructions selected for transmission 1002, a user input area 1003, and an option to send 1004 the selected instructions to the recipient patient. A user may choose to enter in patient address information in area 1001, such as a recipient patient's email address, mobile phone number, or other unique patient identifier user name or number. Alternatively, the user may type in a user's name and the mobile application may display a list of previously entered patients who have already given consent to receive information through the communication network. The user may also be provided with an option to add additional instructions to those already selected. Upon selection of the option to send 1004, the communication network will transmit links to the selected instructions to the identified patient. The mobile application may display an indication to the user to ensure that they have the patient's permission to send them links using the communication network. The selection of the option to send 1004 also triggers the communication network to begin the HIPAA authentication workflow procedures. However, these procedures are conducted between the communication network and the recipient patient, and do not require further action or input from the health care provider. The links may be sent in an email, text message, message within a patient's mobile application, or link displayed on a webpage accessible by the patient but in any event the message will not go through the servers or other equipment of the communication network since consent has not yet been granted. The links may direct the patient to webpages hosted by the communication network, or may open informational and instruction pages within a mobile application accessed by the user.

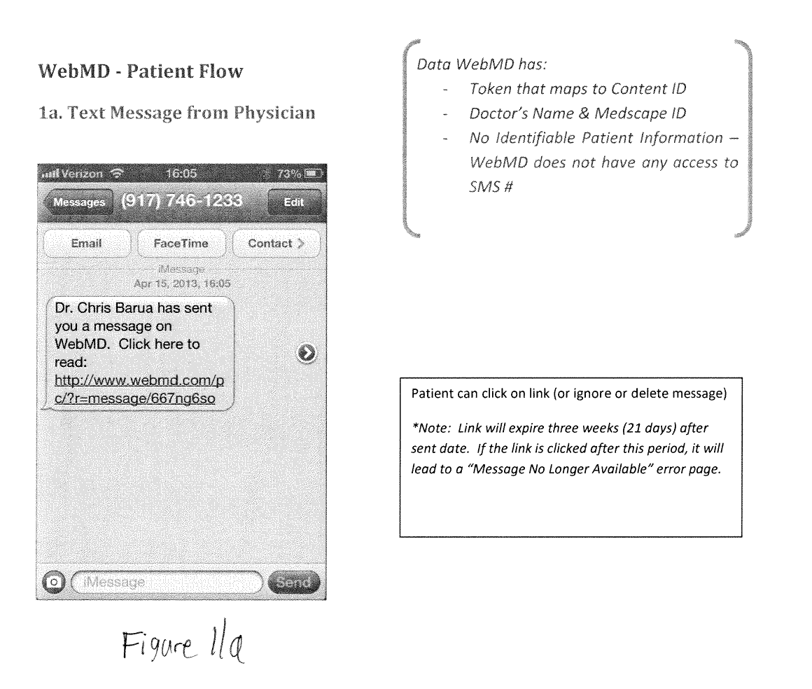

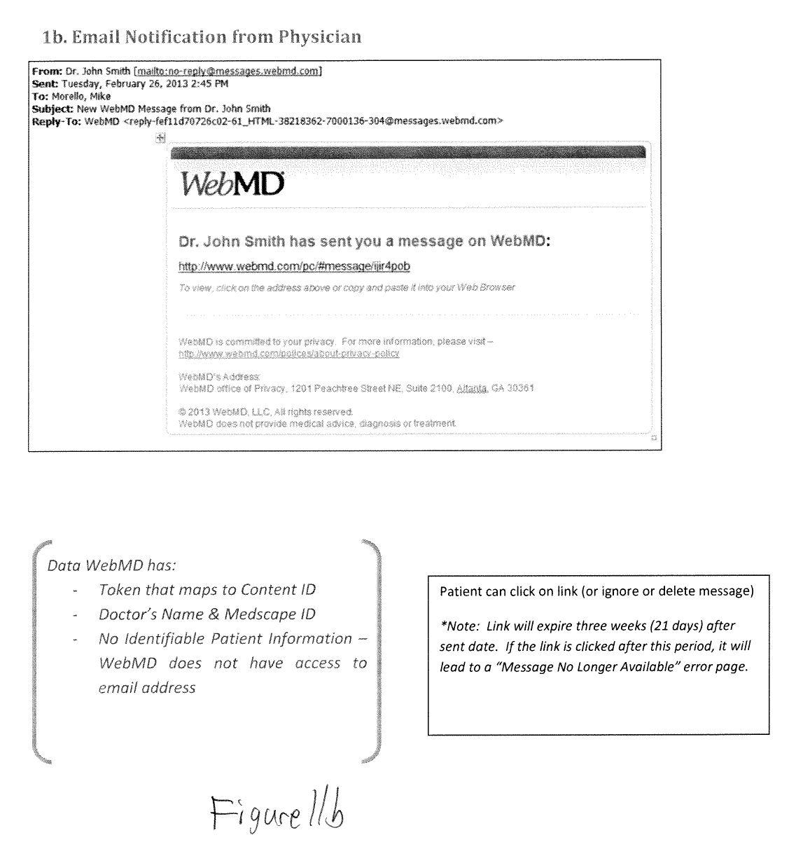

After a health care provider user has completed the above described process, the sent instructions or message will be transmitted from the communication network to the recipient patient. However, in order to ensure that the patient's privacy is maintained, no identifiable patient information will be accessible to the communication network until the patient has completed a consent procedure. A consent module within the mobile application may contain program instructions to transmit a message a message to the communication network service to implement a consent procedure between the patient, communications network service, and health care provider. FIGS. 11a and 11b illustrate the patient flow procedures within the communications network after a health care provider has sent instructions to a specific recipient patient. FIG. 11a provides an example of a patient receiving a text message indication that a health care provider wishes to send them a message, while FIG. 11b provides an example of patient notification through email. As noted above, patients may also be notified that they have a message from a health care provider through other communication means, such as a message indication on a website accessible by the patient, or a message indication within a patient mobile application also run by the communication network.

As shown in FIG. 11a, the recipient patient may receive an indication that their health care provider wishes to send them a message through a text message. The text message may include a brief message, as well as a link containing token information to map to the instruction content sent by the health care provider, as well as the health care provider's mobile application identification. The message text may include the name of the physician or other health care provider sending the message, and an identification of the communication service used to share the messages. Notably, the text message does not contain any patient health information, and the communication network does not have access to the SMS#. Therefore, the confidentiality of the patient's health information is maintained prior to, and during, the process requiring the patient to give consent for sharing of information. According certain embodiments, the link transmitted in the text message may have a fixed expiration period. If the patient attempts to access the link after the expiration period has passed, they may be directed to a webpage informing them that message is no longer available. In an alternative embodiment, and as illustrated in FIG. 11b, the patient may receive the message in an email format instead of a text message. As with the text message, the email does not contain any patient information, and the communication network will not have any access to the patient's email address. If the patient desires to receive the message from their health care provider within the communication network service, they have the option to select the link to be directed either to a consent procedure if it is their first time receiving a message within the service, or to a sign in page if they have already given consent and are registered to receive messages within the service.

Any user receiving a message within the service for the first time will be automatically directed by the consent module to a consent page. Users may also be automatically directed to the consent page if they have previously declined consent, or after a certain period of time has passed since the patient gave consent. The consent page may include text informing the patient that their health care provider would like to provide or exchange information with them through the communication network, but that in order to do so the health care provider will need to disclose some information about the patient's health to the communication network service so that the service can provide health information selected by the health care provider. The consent page may then contain an authorization from the patient, with options for the patient to either agree to give consent or to cancel the procedure. Part of this authorization may be an acknowledgement that the patient's health information will be treated in accordance with communication network service's privacy policies, and may no longer be protected by federal or state privacy laws or regulations such as HIPAA.

The consent page may be displayed as a webpage accessible over the internet. The web page may be hosted by the communication network service provider. Alternatively, the consent page may be sent as an email with selectable links embedded therein, or as a page within a mobile application. As with the transmitted messages described in FIGS. 11a and 11b above, the only information the communication network has at this time is a content ID token that maps to the content sent by the health care provider, a link to the content embedded within the token, and the name and mobile application ID of the health care provider who sent the message. The communication network does not have access to any identifiable patient information. Within the consent page, the patient may view the communication network's privacy policy via a link or as a pop-up window.

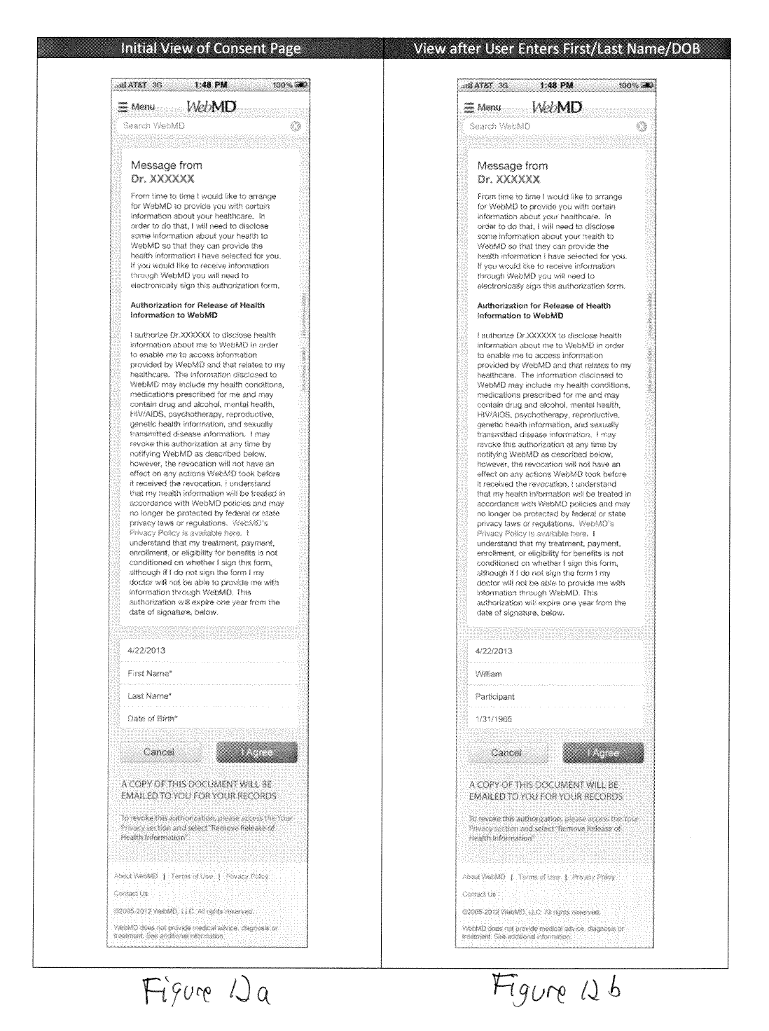

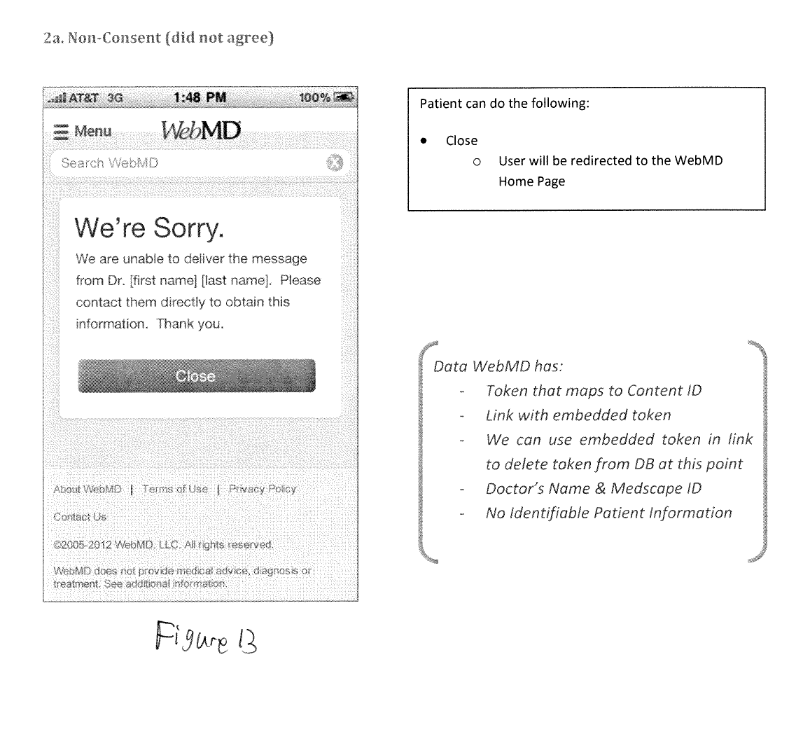

As mentioned above, the patient may choose to cancel the consent procedure after reading the consent page and authorization information. If they choose not to agree to the consent, a series of procedures will be initiated to cancel the message process. First, the patient may receive a message asking if they are sure they would like to cancel the consent procedure, and information them that the message from their health care provider will no longer be available if they continue with cancellation. This message will allow users who accidentally selected a cancel option with the consent page to continue the process without losing the message from their health care provider. If the patient chooses to consent to allowing personal information related to their health to be shared with the communication network, they can choose to agree to the authorization on the consent page. In order to agree, the patient may be required to enter certain information, such as their name, date of birth, and date of consent. Examples of a consent page before and after a patient enters the required information to agree are shown in FIGS. 12a and 12b.

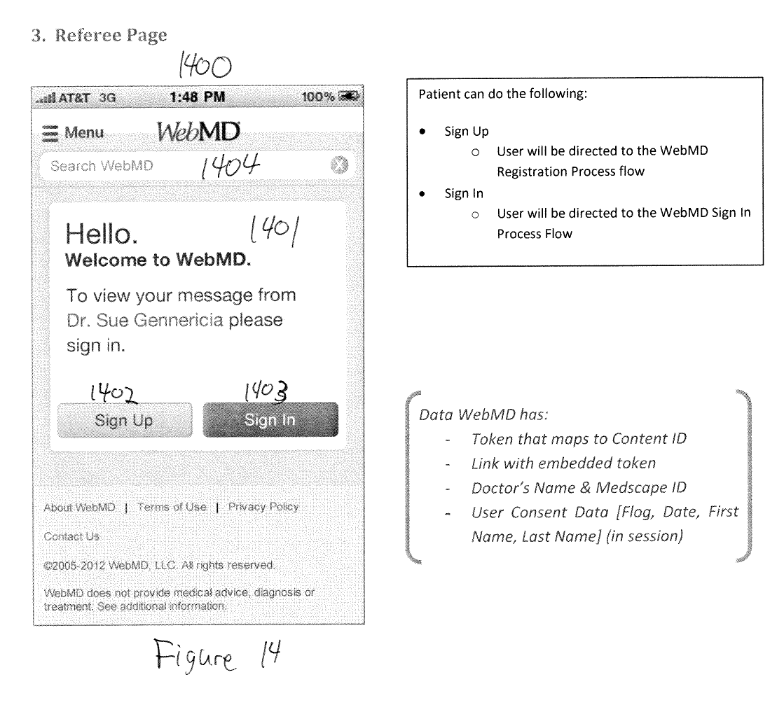

FIG. 13 is an example of a message delivered to a patient declining consent. This message may be provided as a text message, in an email, part of a webpage, or as a message within a mobile application. The message may inform the patient that the service is unable to deliver the message from their health care provider, and may request that the patient directly contact the health care provider to receive the information. When provided as part of a webpage or within a mobile application, the use may be presented with an option to close the message. Closing the message may direct the patient to the homepage of the communication network service. At this time, the communication network service may use the embedded token from the link in the original message to delete the token and message from the service's database. The communication network service may also use the token from the link to inform the health care provider who sent the original message that the patient declined consent. The text of the link does not contain any words or terms that would provide an indication of the content enclosed therein. Instead, the link is intentionally generated by the system in code so that the content cannot be determined from reading the link itself. This helps to ensure that the patient's privacy is maintained before they complete the consent and complete the authorization process.

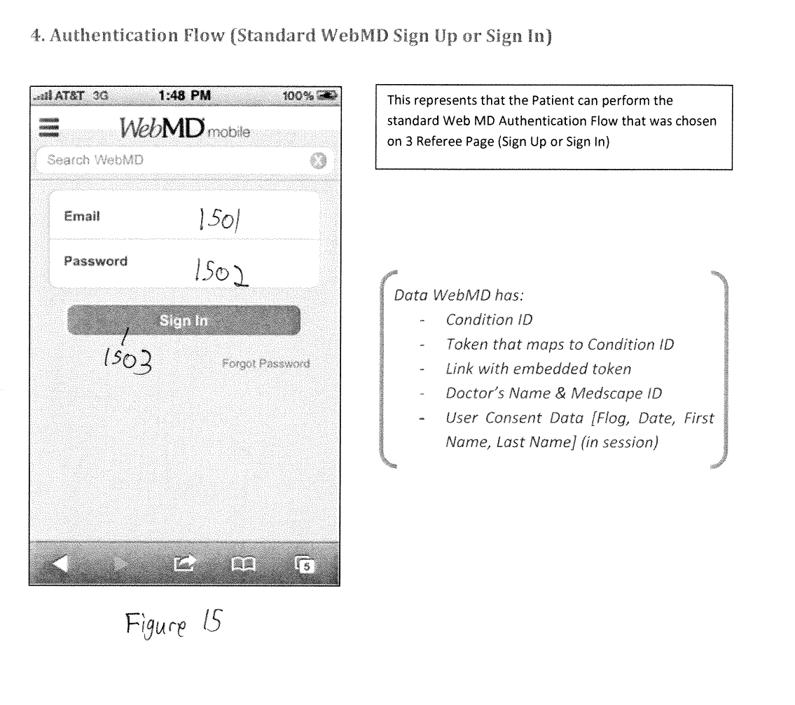

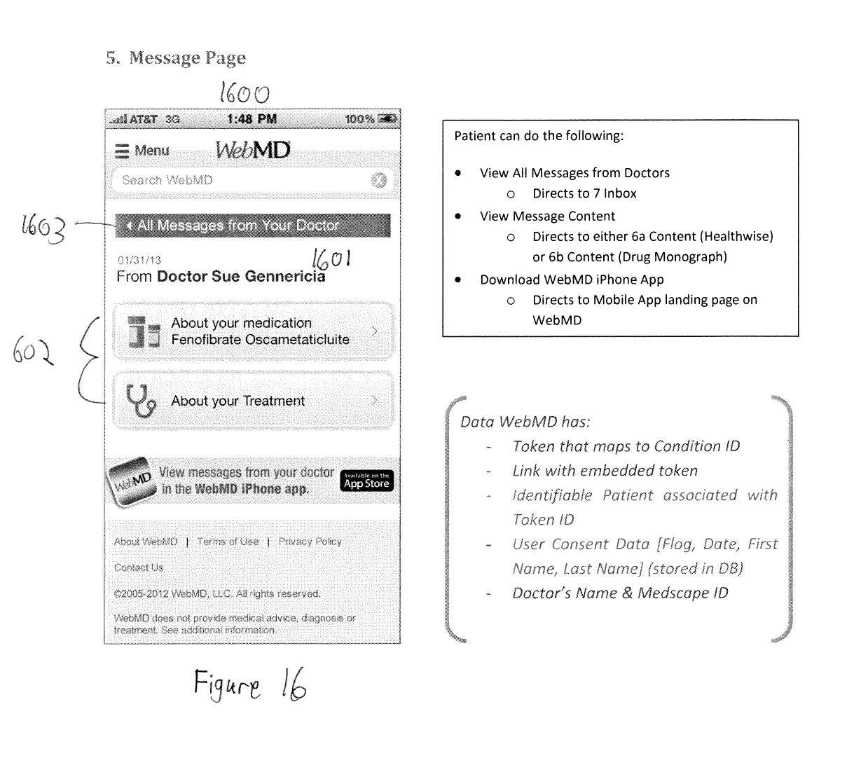

If the patient agrees to consent and completes the authorization on the consent page, they may be directed to a referee page by an information provider module within the application. The information provider module may be configured to transmit the specified confidential information to the patient in response to the patient granting consent. The referee page may request the user to sign up for the communication network services, thereby allowing information to be shared between the patient and their health care provider. A user interface may be provided displaying the referee page, either in the form of a webpage or a mobile application, for the patient to access the communication network service. As shown in FIG. 14, the referee page 1400 may provide the patient with a welcome message 1401 informing them that they have a message waiting from a health care provider. The referee page 1400 may also include selectable options for a user to either sign up 1402 for the service if it is their first time visiting the page, or to sign in 1403 if they are already registered. A search window 1404 may also be provided for the patient to search information within the general home website of the communication network service. If a user chooses the sign in option 1402, they will be directed to a registration process flow where they create a user name, password, and provide additional information necessary to become an active member of the service. Registered users may select the sign in option 1403, at which time they will be directed to a sign in page as shown in FIG. 15. The sign in page 1500 may include an area for a user to enter an identifying user name or email address 1501, as well as a password 1502. Upon entering the required user name and password, the user may select an option 1503 to sign in and be directed to a message based on the token and content ID. Alternatively, the user may be directed to a general message inbox or homepage. At this time in the process, the communication network service has information related to the token that maps the content ID of the message sent by the health care provider, the link embedded within the token, the health care provider's name and member ID, and the user's consent data.

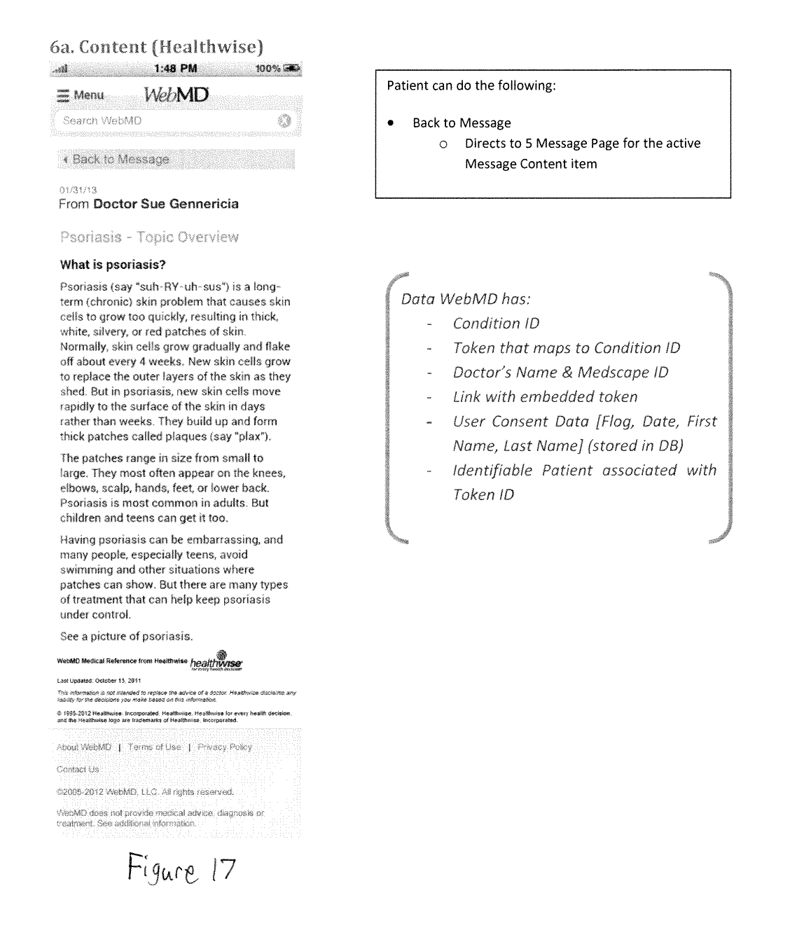

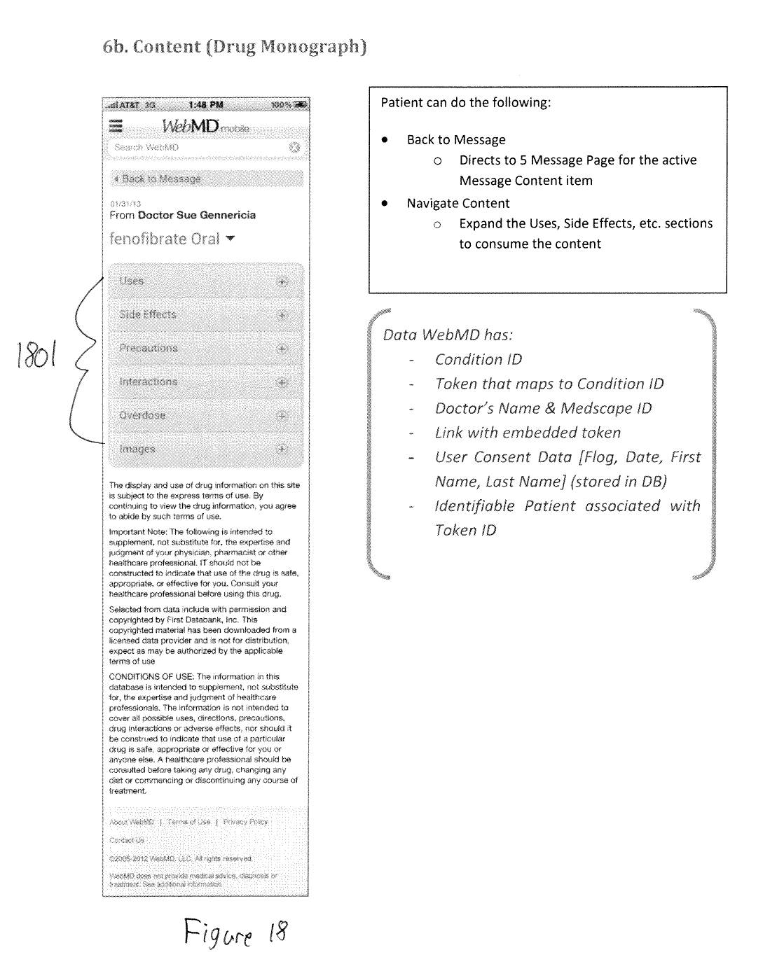

FIG. 16 is an example of a user interface displayed to the patient following the sign-in procedure. As shown in FIG. 16, the user interface may be in the form of a message page 1600. The message page 1600 may include a selectable option 1603 for the user to return to a general inbox containing all of the user's messages within the service. The message page may have a message display area 1601 where the message content, including instructions, sent from the health care provider is displayed. This area 1601 may identify the name of the health care provider sending the message, as well as the date the message was sent. The display area 1601 may also provide selectable options 1602 for the patient to view the content of the message from their health care provider. The selectable options may be for information such as drug content information, treatment information, disease information, or any other type of health related information. FIG. 17 provides an example of a user display of selected message content related to a disease or condition. FIG. 18 provides an example of a user display of selected message content related to drug information. As shown in FIG. 18, the displayed message content may be navigable. For example, the display may provide expandable headings related to different aspects of the message content, or may include links to related information or specific details on the content. When a patient is viewing messages within the communication network service, the service will have access to the condition or content ID being viewed by the patient, the token mapping to the condition or content ID, the health care provider's name and member ID who sent the original message, the link embedded within the token, the user consent data, and identifiable patient information now associated with the token ID following the user's sign-in completion.

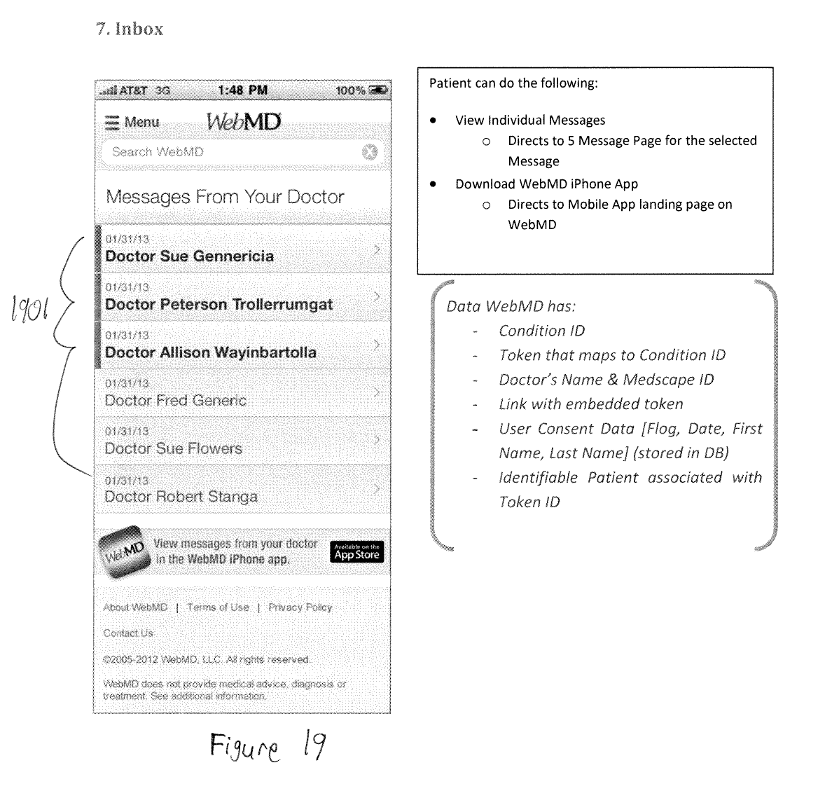

FIG. 19 is an illustration of a user's general message inbox or homepage. This inbox or homepage may display a selectable list of all of the patient's messages. The inbox may include an indication of which messages are new and which messages are old, and may further provide options for the user to save or delete certain messages.

If the user is viewing the information within a webpage, the webpage may provide a selectable option for the user to view the messages within a mobile application instead. Selection of this icon will direct the user to either download the mobile application, or will open the mobile application if the user already has the mobile application installed on their user device. This option to switch from a webpage to a mobile application may be provided on any webpage of the communication network service.

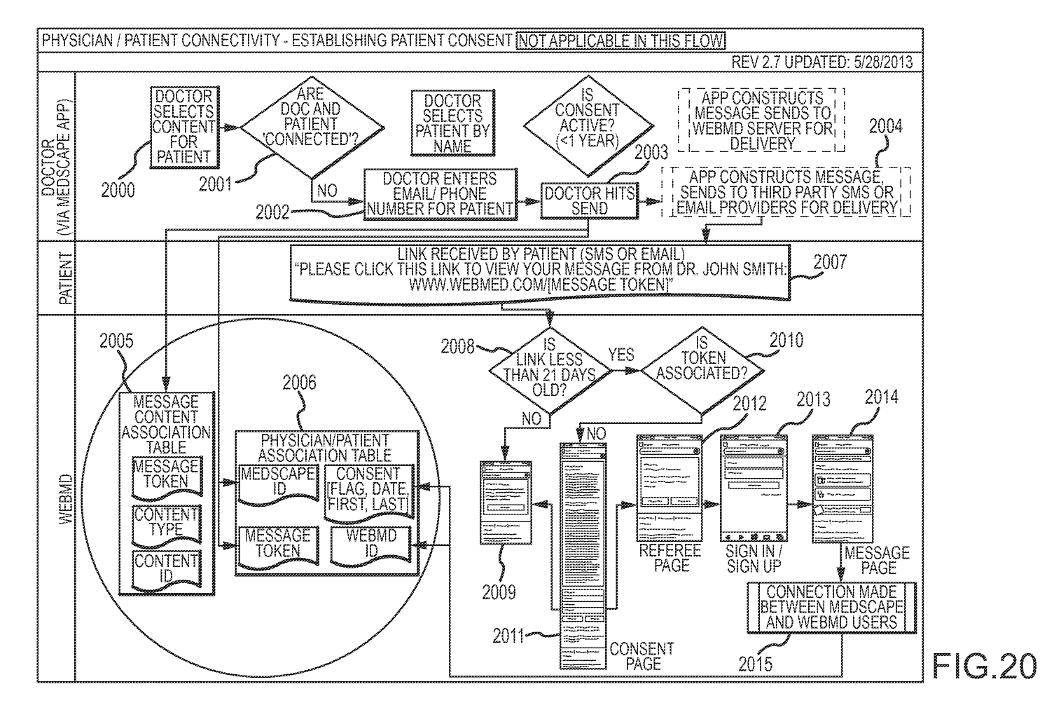

FIGS. 20-22 are examples of the data workflow and process steps involved in establishing health care provider and patient connectivity within the communication network service. FIG. 20 is an example process for establishing patient consent within the communication network service to allow messages to be transmitted from a health care provider to a patient. As shown in FIG. 20, a doctor or other health care provider, using a first network application, may first select content from an information provider and request that this content is distributed to a patient or other recipient as shown at 2000. The system may include a database of existing relationships between health care providers and other information recipients, indicating whether there are pre-established connections and consent for information exchange between the two. After the doctor or health care provider selects the content and requests that it is distributed a particular recipient, the first network application may query the database 2001 to determine if the two are already connected. If no previous connection is found in the database, the health care provider may be prompted to enter contact information for the intended recipient as shown at 2002, such as an email address or telephone number. At 2003, the health care provider selects an option to send the request for content and distribution. This request is sent to the consent module within the first network application and to the information content provider. At 2005, the information content provider associates the requested content with a specified message token, content type, and content ID. At 2006, the information content provider further sends the massage token and a user ID for the requesting provider to the database of existing relationships between health care providers and other information recipients. In this instance, as the recipient has not yet provided consent, the database will not show an association between the health care provider and intended recipient for the message token related to the requested content. The information content provider will have the requesting health care provider's user ID and name, and will have the message token that maps to the requested content ID. However, the information content provider will not have any information on the intended recipient of the information, and will not receive such information until the consent procedure is completed. Therefore, the consent module within the first network application constructs a message including a link to inform the intended recipient that the health care provider wishes to share certain information with them at 2004. The message including the link may be sent as an electronic message, such as text message or email. The link may have the token that maps to the Content ID and the health care provider user ID and name. However, the link will not contain any identifiable recipient information.

The recipient receives the message containing the link at 2007. Each link may be programmed to expire within a certain time period after it is initially sent. When the recipient selects the link, a check may be performed to determine if the link has expired at 2008. If the link has expired, the link may lead to a webpage or page within a second network application on a recipient's mobile device indicating that the message is no longer available, as shown at 2009. If the link is still active and has not expired, then at 2010 the system checks to determine if the message token is associated with both a requesting health care provider's ID and an intended recipient's ID, including indicating the intended recipient has already consented to allow the information provider to have access to the recipient's medical information to facilitate the distribution of the requested content.

When there is no association, and the recipient has not yet provided consent, the recipient at 2011 is directed to a consent page as described in FIGS. 12a and 12b above. Upon completing the consent procedure in the consent page and granting consent, the patient may then be directed to a referee page at 2012. The details of the referee page are described above in reference to FIG. 14. On the referee page, the recipient may make a selection to either sign in or sign up, and are directed at 2013 to a sign in/sign up page as detailed in FIG. 15. After signing in, the user is directed at 2014 to the message page which displays messages containing the content the healthcare service provider requested in the initial step. In addition, a connection is made between the user ID of the requesting healthcare provider and the recipient at 2016. This connection is stored in the relationship database, which will now associate the requesting provider's ID with the recipient's ID along with an indication that consent has been given for information to be shared through the information content provider.

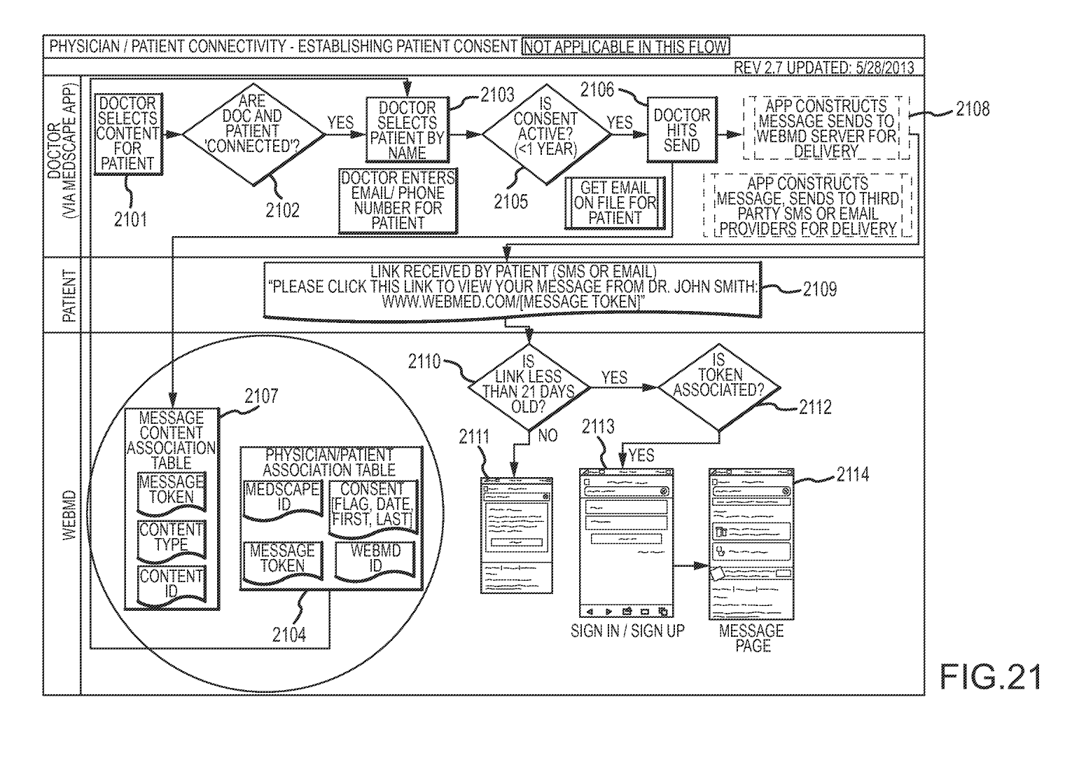

FIG. 21 is an example of the process for transmitting a message and message content from a health care provider to a patient within the communication network service when both the health care provider and patient are already registered members, and wherein the patient's consent is currently active. As shown in FIG. 21, a doctor or other health care provider, using a first network application, may first select content from an information provider and request that this content is distributed to a patient or other recipient as shown at 2101. At 2102, the first network application may query the database to determine if the two are already connected. As both the health care provider and patient are already registered members, and the patient's consent is currently active in the example the requesting healthcare provider selects the intended recipient at 2103. The selection may be by recipient name, recipient user name, recipient contact number or email address. This selection is compared, at 2104, to the association of the healthcare provider's user ID, the recipient ID, the recipient consent information, and message tokens for the healthcare provider and recipient within the information provider database.

At 2105, a check is performed to ensure that the consent is still active, and if the consent is active the healthcare provider is able to select an option at 2106 to send the request for content and distribution. This request is sent to the consent module within the first network application and to the information content provider. At 2107, the information content provider associates the requested content with a specified message token, content type, and content ID. At 2108, the first network application constructs a message including a link to the request content, and sends this message to the intended recipient registered with the information content provider. The recipient receives the message containing the link at 2109. Each link may be programmed to expire within a certain time period after it is initially sent. When the recipient selects the link, a check may be performed to determine if the link has expired at 2110. If the link has expired, the link may lead to a webpage or page within a second network application on a recipient's mobile device indicating that the message is no longer available, as shown at 2111. If the link is still active and has not expired, then at 2112 the system checks to determine if the message token is associated with both a requesting health care provider's ID and an intended recipient's ID, including indicating the intended recipient has already consented to allow the information provider to have access to the recipient's medical information to facilitate the distribution of the requested content.

As indicated above, in this example, the requesting provider and recipient are both registered and content is active. Therefore, the recipient is directed at 2113 to a sign in/sign up page as detailed in FIG. 15. After signing in, the user is directed at 2115 to the message page which displays messages containing the content the healthcare service provider requested in the initial step.

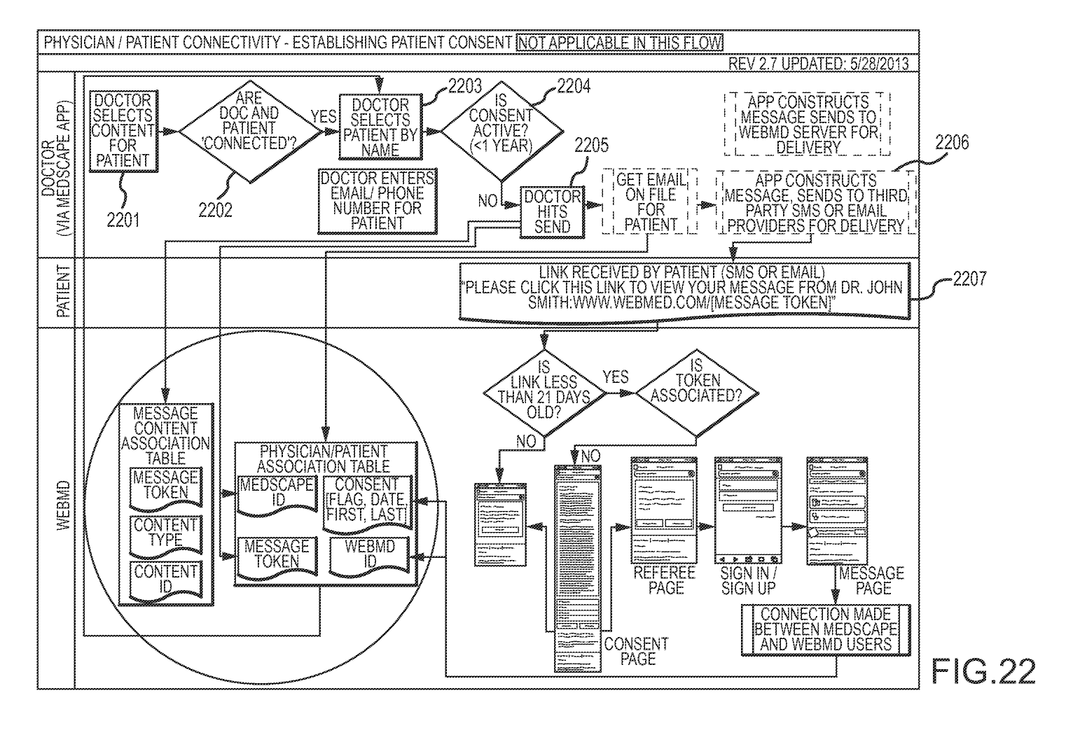

FIG. 22 is an example of establishing connectivity between a health care provider and a patient where a patient's previous consent has expired. FIG. 22 follows a similar procedure as illustrated in FIG. 21. The requesting physician selects desired content for transmission from a content provider to an intended recipient at 2201. At 2202, the check is performed to see if the requestor and intended recipient are connected. As they are already connected, the requestor is able to select the intended recipient, such as by name, number, or email address at 2203. However, in this example, when the check is performed at 2204, a determination is made that the consent is no longer active. However, because the two are already connected, the information provider database has contact information for the intended recipient. Therefore, when the requesting healthcare provider chooses to send the request for content and distribution, the first network application and information provider database communicate to retrieve a contact address for the intended recipient at 2205. Once this contact address, which may be an email address or telephone number, is retrieved, the first network application constructs a message including a link to inform the intended recipient that the health care provider wishes to share certain information with them at 2206. The message including the link may be sent as an electronic message, such as text message or email. The link may have the token that maps to the Content ID and the health care provider user ID and name. However, the link will not contain any identifiable recipient information.

The recipient receives the message containing the link at 2207, and the process described in FIG. 20 to obtain consent following the recipient selecting the link is repeated. Once the consent has been re-established, the healthcare provider and intended recipient may share health related information through the information service provider.

Although the previous description has been provided in the context of sharing health care information, this is for illustrative purposes only and the message and consent procedures described herein may have applications in other areas outside of health care information. For example, the message and consent procedure may be used in sharing financial information between banks or financial advisors and their clients, with the information coming from a third party service.

1. A system for enabling a first party to, through a single action, request a third party to obtain consent from a second party to transmit confidential information and to then provide confidential information specified by the first party to the second party, the system comprising:
a user interface connected to a server, wherein the user interface is configured to receive a single-action request from a first party;
a consent module connected to the server, wherein the consent module is configured to automatically transmit a message to the second party in response to the single-action request being received, the message including a consent form that provides selectable options for the second party to agree to allowing the server to send and receive confidential information regarding the second party; and
an information provider module configured to transmit the specified confidential information to the second party in response to the consent module indicating the second party has granted consent.

2. The system of claim 1, wherein the confidential information is educational information.

3. The system of claim 1, wherein the information provider module transmits the specified information without requiring any additional action by the first party.

4. The system of claim 1, wherein the identity of the second party is not ascertainable by the third party until the consent module indicates that consent has been granted.

5. A method for automatically initiating a consent process to allow a third party to communicate confidential information between a first party and a second party, the method comprising:
receiving a single-action request from a first party at the third party, wherein the single-action request contains both a request for the third party to obtain consent from the second party and an identification of specified information to be transmitted to the second party;
automatically transmit a message from the third party to the second party in response to the single-action request being received, the message including a consent form that provides selectable options for the second party to agree to allowing the server to send and receive confidential information regarding the second party;
receiving, at the third party, an indication from the second party either granting or denying consent; and
in response to the second party granting consent, the third party automatically transmitting a message to the second party providing the second party with access to the specified information.

6. The method of claim 5, wherein the confidential information is educational information.

7. The method of claim 5, wherein the third party transmits the specified information without requiring any additional action by the first party.

8. The method of claim 5, wherein the identity of the second party is not ascertainable by the third party until consent has been received from the second party.
